(19) United States
(12) Patent Application Publication
(10) Pub. No.: US 2019/0131835 A1
(43) Pub. Date: May 2, 2019

(54) Rotor for a Motor

(71) Applicant: Sunonwealth Electric Machine Industry Co., Ltd., Kaohsiung City (TW)

(72) Inventors: Alex Horng, Kaohsiung City (TW); Chih-Ming Wu, Kaohsiung City (TW); Chia-Wei Hsiao, Kaohsiung City (TW)

(21) Appl. No.: 15/871,239

(22) Filed: Jan. 15, 2018

(30) Foreign Application Priority Data
Oct. 27, 2017 (TW) 106137171

(51) Int. Cl. H02K 1/27; H02K 1/28; H02K 15/03; H02K 21/14

(52) U.S. Cl. CPC H02K 1/2713; H02K 21/14; H02K 15/03; H02K 1/28

(57) ABSTRACT

A rotor for a motor according to the invention is provided to solve the problem where the rotor of the conventional motor does not have an excellent vibration-reducing effect. The rotor for the motor includes a shaft, an elastic sleeve, a permanent magnet and two engaging units. The elastic sleeve is fit around the shaft. The permanent magnet is fit around the elastic sleeve. The elastic sleeve and the permanent magnet have two sides spaced from each other in an axial direction. The two engaging units are coupled with the elastic sleeve and the permanent magnet at the two sides, respectively. Each of the two engaging units includes a through-hole through which the shaft extends. The two engaging units are not in contact with the shaft.

### CROSS REFERENCE TO RELATED APPLICATION

The application claims the benefit of Taiwan application serial No. 106137171, filed on Oct. 27, 2017, and the contents of which are incorporated herein by reference.

### BACKGROUND OF THE INVENTION

### 1. Field of the Invention

The present invention generally relates to a rotor for a motor and, more particularly, to a rotor for use in an inner-rotor motor.

### 2. Description of the Related Art

In early times, the rotor used in an inner-rotor motor includes a shaft and a magnetic member. The magnetic member is press fit around the shaft or fixed to the shaft via a plurality of bonding blocks, permitting the shaft to rotate jointly with the magnetic member. An example of such a rotor is disclosed in Taiwan Patent No. 1572125 and U.S. Patent Publication No. 2007/0273227.

However, the magnetic member can break under the press fitting between the shaft and the magnetic member. Also, the shaft and the magnetic member cannot be securely coupled with each other under the use of the bonding blocks. Therefore, the currently available rotor often causes some issues such as unstable rotation, low operational efficiency and noise of the motor.

In light of the above, FIG. 1 shows another conventional rotor 9 for a motor. The rotor 9 includes a shaft 91, a magnetic member 92 and two fixing seats 93. The magnetic member 92 includes a shaft hole 921 at a center thereof. The shaft 91 extends through the shaft hole 921 such that the magnetic member 92 is engaged with the shaft 91 in a slight press fitting or a loosening fitting. Each of the fixing seats 93 is press fit around the shaft 91. The two fixing seats 93 clamp and position the magnetic member 92 in a predetermined location. An example of such a rotor 9 is disclosed in U.S. Patent No. 2009/0284094.

Although the rotor 9 can effectively prevent breakage of the magnetic member 92 while securely fixing the magnetic member 92 to a predetermined portion of the shaft 91, the magnetic member 92 will be magnetically excited by the stator of the motor. As a result, the shaft 91 is driven to rotate in a high speed and the vibration is generated during the rotation of the rotor 9. The vibration is transmitted to the two fixing seats 93 and further to the shaft 91 through the two fixing seats 93. Thus, the entire motor generates vibration during the operation, such that not only the noise is generated but also the operation of the motor is unsmooth and the service life of the motor is shortened.

In light of this, it is necessary to improve the currently available rotor.

### SUMMARY OF THE INVENTION

It is therefore the objective of this invention to provide a rotor for a motor which can effectively reduce the vibration transmitted to the shaft during the operation of the motor.

In an aspect, a rotor for a motor according to the invention includes a shaft, an elastic sleeve, a permanent magnet and two engaging units. The elastic sleeve is fit around the shaft. The permanent magnet is fit around the elastic sleeve. The elastic sleeve and the permanent magnet have two sides spaced from each other in an axial direction. The two engaging units are coupled with the elastic sleeve and the permanent magnet at the two sides, respectively. Each of the two engaging units includes a through-hole through which the shaft extends. The two engaging units are not in contact with the shaft.

Based on this, the rotor for the motor according to the invention can reduce the vibration through the elastic sleeve fit around the shaft while securely positioning the elastic sleeve and the permanent magnet through the engaging units that are not in contact with the shaft. In this regard, the vibration is not further transmitted to the shaft, significantly reducing the vibration transmitted to the shaft during the operation of the motor. Advantageously, the operation of the motor is more smooth, the performance of the motor is improved, the noise generated during the operation is reduced, and the service life of the motor is prolonged.

In an example, the two engaging units press the permanent magnet to securely position the permanent magnet, attaining a secure positioning effect.

In an example, each of the two engaging units has a maximum diameter smaller than a maximum diameter of the permanent magnet. This prevents the engaging units from colliding with the stator of the motor during the operation of the rotor of the motor, prolonging the service life of the rotor of the motor.

In an example, the elastic sleeve has a shaft hole through which the shaft extends, and a diameter of the shaft hole is smaller than a diameter of the shaft. Thus, the elastic sleeve can deform under elasticity and abut with the outer periphery of the shaft, effectively absorbing the vibration transmitted to the elastic sleeve. As a result, the vibration is not transmitted further to the shaft easily, thereby improving the smoothness of rotation of the rotor of the motor.

In an example, the shaft includes a limiting portion on an outer periphery thereof, and the elastic sleeve is formed along the outer periphery of the limiting portion by injection. Thus, the coupling effect between the shaft and the elastic sleeve and the convenience in assembly of the rotor of the motor can be improved.

In an example, the elastic sleeve is made of rubber or silica gel to attain a better vibration-reducing effect.

In an example, an angled guiding portion is formed on an outer periphery of the permanent magnet at each of two ends of the to permanent magnet spaced from each other in the axial direction. Each of the two engaging units forms an engaging portion on an outer periphery of the engaging unit. The engaging portion holds the angled guiding portion. Thus, the two engaging units can position the permanent magnet more securely, reinforcing the coupling reliability.

In an example, the rotor for the motor further comprises a magnetic yoke sandwiched between the elastic sleeve and the permanent magnet. Thus, the performance of the motor is improved.

In an example, the two engaging units press the magnetic yoke to thereby position the magnetic yoke more securely, reinforcing the coupling reliability.

In an example, the elastic sleeve includes a plurality of through-holes. Each of two engaging units includes a plurality of positioning holes axially aligned with the plurality of through-holes, respectively. A fastener extends through one of the plurality of positioning holes and a respective one of the plurality of through-holes. Thus, the elastic sleeve and the two engaging units can be securely coupled together via a simple structure, improving the efficiency in assembly.

In an example, the fastener is a screw. Each of the plurality of positioning holes is a threaded hole threaded through by the fastener. Thus, the efficiency in assembly is improved.

In an example, a plurality of nuts is integrally formed by injection on each of two ends of the elastic sleeve spaced from each other in the axial direction. Each of the two engaging units includes a plurality of positioning holes. A fastener is screwed through one of the plurality of positioning holes and a respective one of the plurality of nuts, attaining a higher efficiency in assembly.

In an example, the two engaging units are respectively adhered to two ends of the elastic sleeve spaced from each other in the axial direction. Thus, the efficiency in assembly is improved.

In an example, each of the two ends of the elastic sleeve is provided with a positioning protrusion. Each of the two engaging units is fit around the positioning protrusion via the through-hole thereof. This ensures that the two engaging units can be properly mounted to the two ends of the elastic sleeve without making contact with the shaft during the assembly of the engaging units. As a result, the assembly efficiency of the rotor can be improved and the effect in reducing the vibration transmitted from the elastic sleeve to the shaft can be improved

In an example, each of two ends of the permanent magnet spaced from each other in the axial direction includes a first engagement portion. Each of the two engaging units includes a second engagement portion at one of two ends of the engaging unit facing the permanent magnet. Thus, the second engagement portion of each engaging unit can engage with the first engagement portion of a respective end of the permanent magnet, thereby reinforcing the engagement between the engaging units and the permanent magnet while permitting fast alignment between the positioning holes of each engaging unit and the through-holes of the elastic sleeve. Accordingly, the convenient and efficient assembly can be attained.

In an example, one of the first and second engagement portions is in a U shape and another of the first and second engagement portions is in the form of a U-shaped protrusion to permit the first and second engagement portions to be engaged with each other in the axial direction. Accordingly, the convenient and efficient assembly can be attained.

In an example, the permanent magnet is an anisotropic magnet. Thus, the structure of the rotor of the motor can be simplified, attaining convenient and efficient assembly.

In an example, each of the two engaging units includes a recess on an outer periphery thereof facing away from the elastic sleeve. Accordingly, the rotational balance of the motor can be improved.

In an example, each of the two engaging units includes a plurality of notches on an outer periphery thereof. Accordingly, the rotational balance of the motor can be improved.

In an example, each of the two engaging units is made of copper, aluminum or magnetically insulating steel. Thus, the stability of the magnetism of the rotor can be improved.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a cross sectional view of a rotor for a conventional motor.

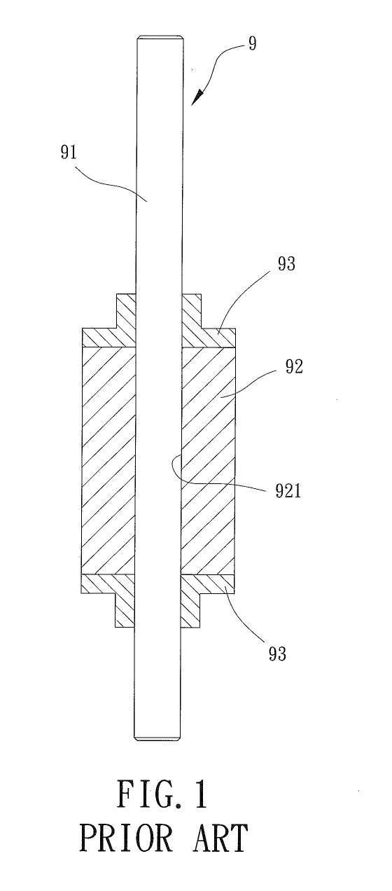

FIG. 2 is an exploded, perspective view of a rotor for a motor according to a first embodiment of the invention.

FIG. 3 is a cross sectional view of the rotor of FIG. 2 after assembly.

FIG. 4 is a cross sectional view of another example of the rotor for the motor according to the first embodiment of the invention.

FIG. 5 is a cross-sectional view of a rotor for a motor according to a second embodiment of the invention.

FIG. 6 is a cross-sectional view of a rotor for a motor according to a third embodiment of the invention.

FIG. 7 is a cross-sectional view of a rotor for a motor according to a fourth embodiment of the invention.

FIG. 8 is an exploded, perspective view of a rotor for a motor according to a fifth embodiment of the invention.

In the various figures of the drawings, the same numerals designate the same or similar parts. Furthermore, when the terms “first”, “second”, “inner”, “outer” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

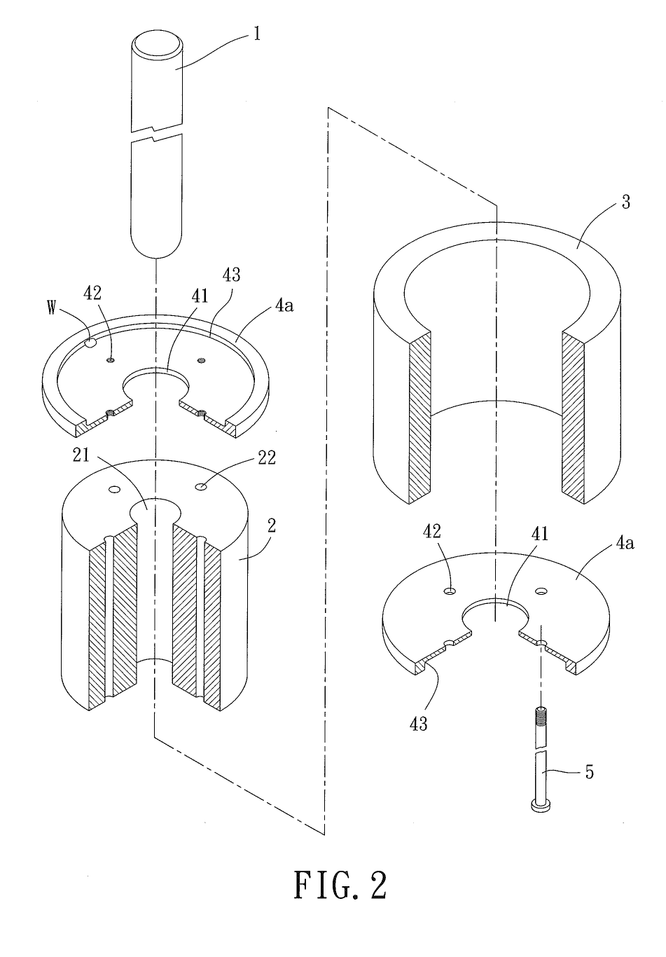

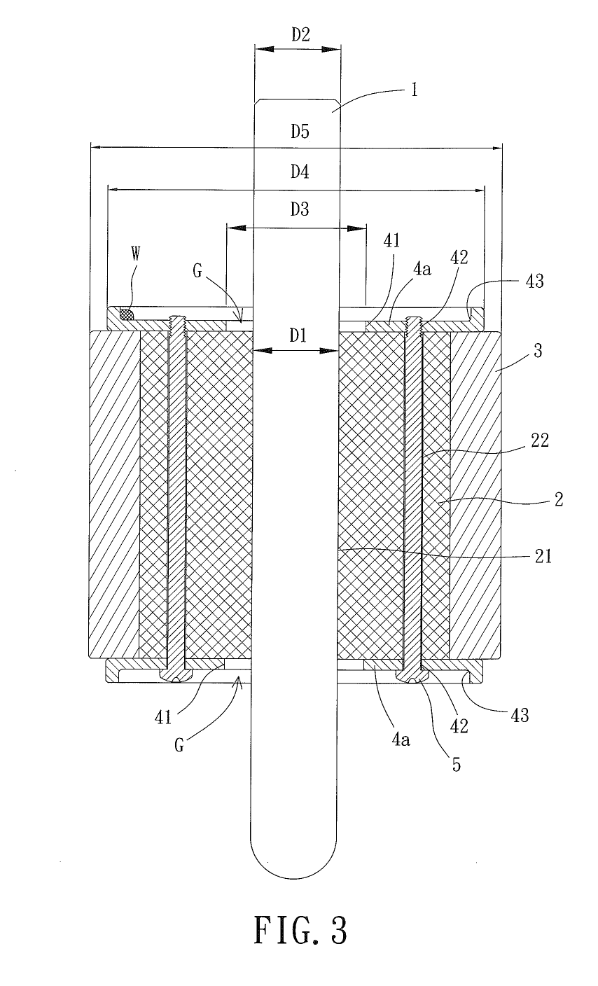

FIGS. 2 and 3 show a rotor for a motor according to a first embodiment of the invention. The rotor includes a shaft 1, an elastic sleeve 2, a permanent magnet 3 and two engaging units 4a. The elastic sleeve 2 and the permanent magnet 3 are mounted around the shaft 1 and are clamped between the two engaging units 4a.

The rotor according to the invention is used in an inner-rotor motor. The shaft 1 is rotatably mounted on a base of the motor. During the operation of the inner-rotor motor, the shaft 1 of the rotor can rotate relative to the base of the motor.

The elastic sleeve 2 is fit around an outer periphery of the shaft 1. In this embodiment, the elastic sleeve 2 abuts with the outer periphery of the shaft 1. The elastic sleeve 2 is made of an elastomeric material such as rubber or silica gel. The elastic sleeve 2 includes a shaft hole 21 through which the shaft 1 extends. In a preferred case, a diameter D1 of the shaft hole 21 is smaller than a diameter D2 of the shaft 1 before assembly, enabling the elastic sleeve 2 to deform under elasticity during the assembly. Thus, the elastic sleeve 2 abuts with the outer periphery of the shaft 1 after assembly to effectively absorb the vibration transmitted to the elastic sleeve 2. As a result, the vibration is not easily transmitted further to the shaft 1.

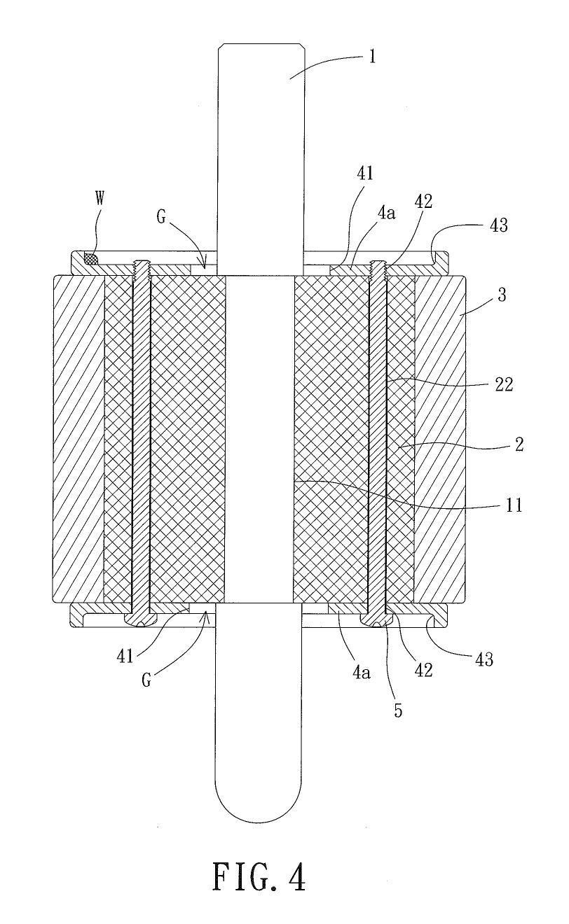

Alternatively, the elastic sleeve 2 is integrally formed with the shaft 1 in another embodiment. In a preferred case, referring to FIG. 4, the shaft 1 includes a limiting portion 11 on an outer periphery thereof. The elastic sleeve 2 is formed along an outer periphery of the limiting portion 11 by injection, thereby reinforcing the engagement between the shaft 1 and the elastic sleeve 2 and improving the convenience in assembly of the rotor. In a non-limiting example, the limiting portion 11 is an annular recess, an embossed surface or a rough surface formed on the outer periphery of the limiting portion 11. Alternatively, a cross section of the limiting portion 11 can be in a non-circular shape. However, this is not used to limit the invention.

Referring to FIGS. 2 and 3, the permanent magnet 3 is mounted around the elastic sleeve 2 to induce a magnetic field with a stator of the motor. The permanent magnet 3 is an annular magnet or consists of a plurality of magnets arranged in an annular manner. The invention is not limited to either option. The permanent magnet 3 is preferably an anisotropic magnet so that the rotor does not need to include a magnetically conductive element that seals the magnetic field of the permanent magnet 3. This advantageously simplifies the structure of the rotor and improves the convenience in assembly.

Each of the two engaging units 4a includes a through-hole 41 through which the shaft 1 extends. The elastic sleeve 2 and the permanent magnet 3 have two sides spaced from each other in an axial direction. The two engaging units 4a are respectively coupled with the elastic sleeve 2 and the permanent magnet 3 at the two sides without making contact with the shaft 1, securely engaging the elastic sleeve 2 and the permanent magnet 3 between the two engaging units 4a. In other words, the through-hole 41 of each engaging unit 4a has an inner diameter D3 larger than the diameter D2 of the shaft 1. Thus, a gap G is formed between an inner periphery of the engaging unit 4a and the shaft 1. When the shaft 1 extends through the through-holes 41 of the engaging units 4a, the engaging units 4a can be free of contact with the shaft 1, attaining a smooth assembly. More importantly, this can also prevent the engaging units 4a from transmitting vibration to the shaft 1 during the operation of the motor. Furthermore, a maximum diameter D4 of each engaging unit 4a is smaller than a maximum diameter D5 of the permanent magnet 3 to prevent the engaging units 4a from colliding with the stator of the motor during the operation of the rotor of the motor.

Besides, the two engaging units 4a preferably abut with the permanent magnet 3 to securely position the permanent magnet 3. The engagement structure between the two engaging units 4a and the elastic sleeve 2 is not limited in the invention. In this embodiment, the elastic sleeve 2 may include a plurality of through-holes 22 extending in the axial direction. Each of the engaging units 4a includes a plurality of positioning holes 42 axially aligned with the plurality of through-holes 22, respectively. Thus, a fastener 5 extends through one of the positioning holes 42 and a respective through-hole 22. For example, the fastener 5 can be a long screw, and each of the positioning holes 42 is a threaded hole to be threaded through by the fastener 5. Alternatively, each of the positioning holes 42 is a simple through-hole without helical grooves, and the fastener 5 includes a long screw and a nut. In this regard, each of two ends of the screw can extend through a respective positioning hole 42 to threadedly engage with the nut. Other structures of the engaging units 4a and the elastic sleeve 2 are described below.

Furthermore, each of the engaging units 4a is made of a metal material such as copper, aluminum or magnetically non-conductive steel in order not to adversely affect the magnetically conductive effect and to stabilize the magnetism of the rotor. Each of the engaging units 4a includes a weighting portion 43. In this embodiment, the weighting portion 43 is a recess on an outer periphery facing away from the elastic sleeve 2 for mounting one or more weights W. This increases the rotational balance of the rotor.

Based on the above structure, the rotor according to the invention permits the rigid components, namely, the shaft 1 and the permanent magnet 3, to be separate from each other by coupling the shaft 1 with the elastic sleeve 2 and by securely positioning the elastic sleeve 2 and the permanent magnet 3 with the two engaging units 4a that do not make contact with the shaft 1. As a result, the elastic sleeve 2 can reduce the vibration and minimize the vibration transmitted to the shaft 1 via the engaging units 4a. Thus, the rotor according to the invention can significantly reduce the vibration that is transmitted to the shaft 1 during the operation of the motor, thus providing advantages such as smoother operation, increased operational efficiency, reduced noise and prolonged service life.

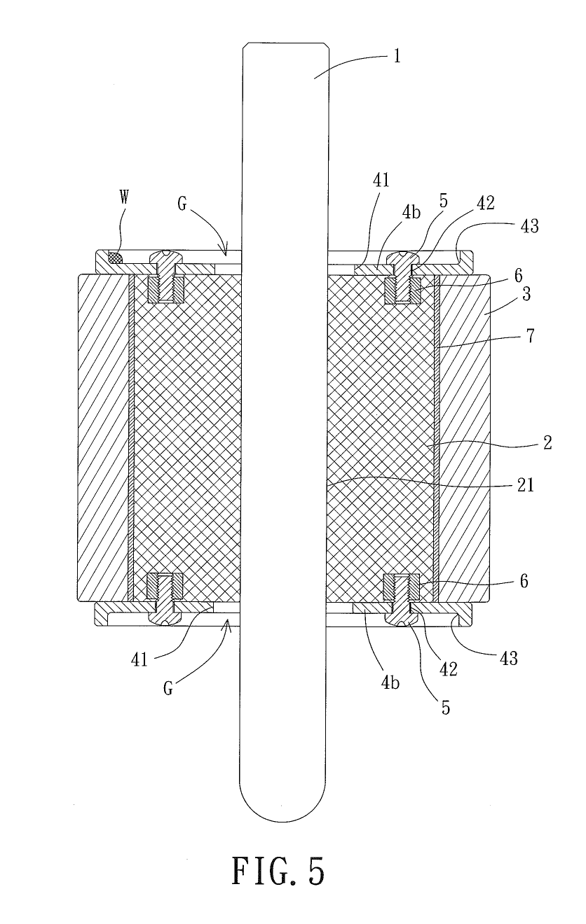

FIG. 5 shows a rotor for a motor according to a second embodiment of the invention. The second embodiment of the invention is substantially the same as the first embodiment except for the engagement structure between two engaging units 4b and the elastic sleeve 2.

Specifically, in the embodiment, a plurality of nuts 6 is integrally formed by injection on each of two ends of the elastic sleeve 2 spaced from each other in the axial direction. Each of the two engaging units 4b includes a plurality of positioning holes 42 and is mounted to a respective end of the elastic sleeve 2. Each of the positioning holes 42 is axially aligned with a respective nut 6. Each of the fasteners 5 is screwed through a respective positioning hole 42 and a respective nut 6 to securely engage the two engaging units 4b with the two ends of the elastic sleeve 2, respectively.

Besides, the rotor preferably includes a magnetic yoke 7 made of a magnetically conductive material. The magnetic yoke 7 is sandwiched between the elastic sleeve 2 and the permanent magnet 3 to improve the performance of the motor. The magnetic yoke 7 is preferably clamped by the two engaging units 4b to attain a secure positioning effect.

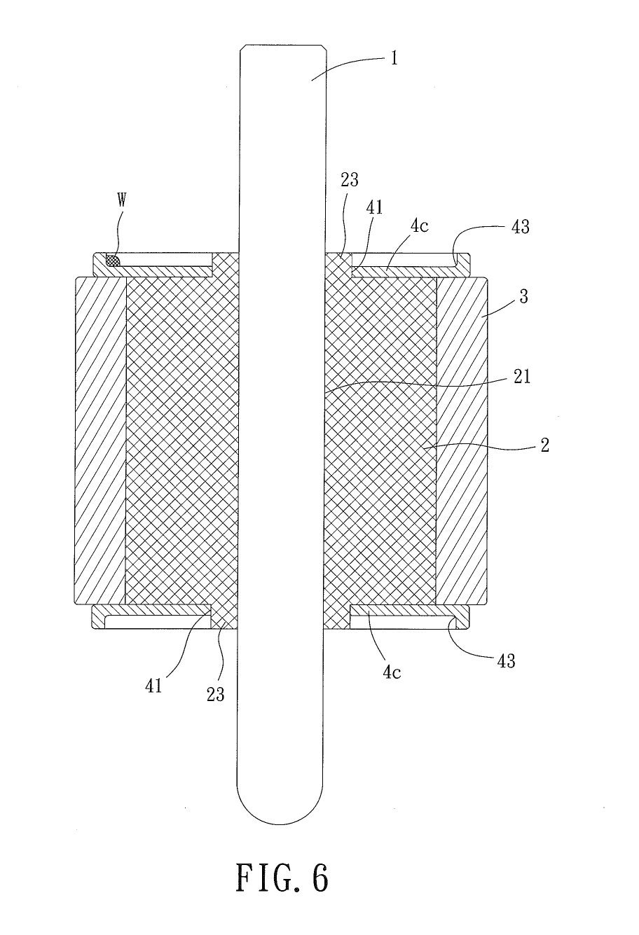

FIG. 6 shows a rotor for a motor according to a third embodiment of the invention where two engaging units 4c are adhered to the two ends of the elastic sleeve 2, respectively. It is worth mentioning that each of the two ends of the elastic sleeve 2 is provided with a positioning protrusion 23 in this embodiment. Each of the two engaging units 4c is fit around the positioning protrusion 23 via the through-hole 41 to ensure that the two engaging units 4c can be properly mounted to the two ends of the elastic sleeve 2 without making contact with the shaft 1 during the assembly of the engaging units 4c. As a result, the assembly efficiency of the rotor can be improved and the effect in reducing the vibration transmitted from the elastic sleeve 2 to the shaft 1 can be improved.

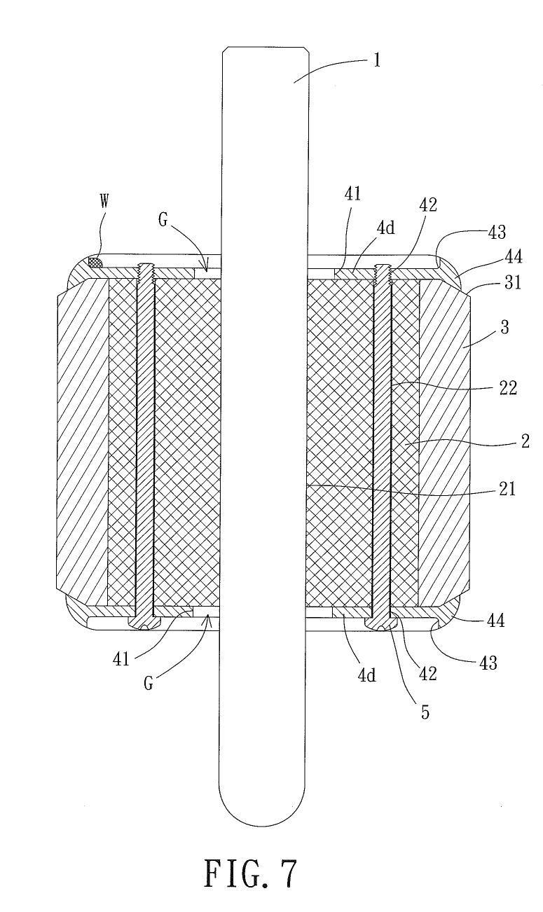

FIG. 7 shows a rotor for a motor according to a fourth embodiment of the invention. The fourth embodiment of the invention is substantially the same as the first embodiment except for the outlines of two engaging units 4d and the permanent magnet 3.

Specifically, an angled guiding portion 31 is formed on an outer periphery of the permanent magnet 3 at each of two ends of the permanent magnet 3 axially spaced from each other. Each of the engaging units 4d forms an engaging portion 44 on an outer periphery thereof. The outer periphery of the engaging unit 4d extends to the permanent magnet 3 in a curve manner to form the engaging portion 44. Alternatively, the engaging portion 44 is in the form of a protrusion extending from the engaging unit 4d towards the permanent magnet 3, permitting the engaging portion 44 to hold the angled guiding portion 31. In this arrangement, the engaging units 4d can position the permanent magnet 3 more securely.

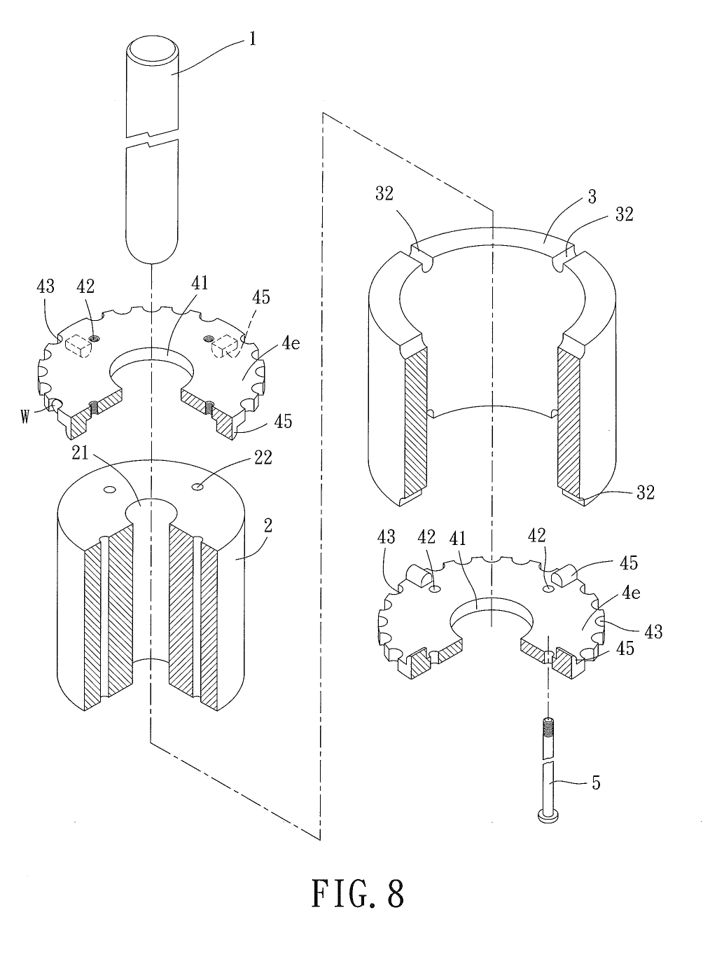

FIG. 8 shows a rotor for a motor according to a fifth embodiment of the invention. The fifth embodiment of the invention is substantially the same as the first embodiment except for that each of the ends of the permanent magnet 3 includes at least one first engagement portion 32 and that each of two engaging units 4e includes at least one second engagement portion 45 at one of two ends of the engaging unit 4e facing the permanent magnet 3. The at least one first engagement portion 32 corresponds to the at least one second engagement portion 45. Thus, the at least one second engagement portion 45 of each engaging unit 4e can engage with the at least one first engagement portion 32 of a respective end of the permanent magnet 3, thereby reinforcing the engagement between the engaging units 4e and the permanent magnet 3 while permitting fast alignment between the positioning holes 42 of each engaging unit 4e and the through-holes 22 of the elastic sleeve 2. Accordingly, the fasteners 5 can screw each engaging unit 4e to the elastic sleeve 2 to attain convenient and efficient assembly.

Each first engagement portion 32 of the permanent magnet 3 structurally matches a corresponding second engagement portion 45. For example, one of the first engagement portion 32 and the second engagement portion 45 is in a U shape while another is in the form of a U-shaped protrusion to permit the first engagement portion 32 and the second engagement portion 45 to be engaged with each other in the axial direction.

On the other hand, in this embodiment, the weighting portion 43 is a plurality of notches arranged on an outer periphery of the engaging units 4e for mounting one or more weights W. In this arrangement, the rotor can have a better rotational balance and operational stability.

Based on the above, the rotor for the motor according to the invention can reduce the vibration through the elastic sleeve fit around the shaft while securely positioning the elastic sleeve and the permanent magnet through the engaging units that are not in contact with the shaft. In this regard, the vibration is not further transmitted to the shaft, significantly reducing the vibration transmitted to the shaft during the operation of the motor. Advantageously, the operation of the motor is smoother, the performance of the motor is improved, the noise generated during the operation is reduced, and the service life of the motor is prolonged.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A rotor for a motor, comprising:
a shaft;
an elastic sleeve fit around the shaft;
a permanent magnet fit around the elastic sleeve, wherein the elastic sleeve and the permanent magnet have two sides spaced from each other in an axial direction; and
two engaging units coupled with the elastic sleeve and the permanent magnet at the two sides, respectively, wherein each of the two engaging units includes a through-hole through which the shaft extends, and wherein the two engaging units are not in contact with the shaft.

2. The rotor for the motor as claimed in claim 1, wherein the two engaging units press the permanent magnet.

3. The rotor for the motor as claimed in claim 1, wherein each of the two engaging units has a maximum diameter smaller than a maximum diameter of the permanent magnet.

4. The rotor for the motor as claimed in claim 1, wherein the elastic sleeve has a shaft hole through which the shaft extends, and wherein a diameter of the shaft hole is smaller than a diameter of the shaft.

5. The rotor for the motor as claimed in claim 1, wherein the shaft includes a limiting portion on an outer periphery thereof, and wherein the elastic sleeve is formed along the outer periphery of the limiting portion by injection.

6. The rotor for the motor as claimed in claim 1, wherein the elastic sleeve is made of rubber or silica gel.

7. The rotor for the motor as claimed in claim 1, wherein an angled guiding portion is formed on an outer periphery of the permanent magnet at each of two ends of the permanent magnet spaced from each other in the axial direction, wherein each of the two engaging units forms an engaging portion on an outer periphery of the engaging unit, and wherein the engaging portion holds the angled guiding portion.

8. The rotor for the motor as claimed in claim 1, further comprising a magnetic yoke sandwiched between the elastic sleeve and the permanent magnet.

9. The rotor for the motor as claimed in claim 8, wherein the two engaging units press the magnetic yoke.

10. The rotor for the motor as claimed in claim 1, wherein the elastic sleeve includes a plurality of through-holes, wherein each of two engaging units includes a plurality of positioning holes axially aligned with the plurality of through-holes, respectively, and wherein a fastener extends through one of the plurality of positioning holes and a respective one of the plurality of through-holes.

11. The rotor for the motor as claimed in claim 10, wherein the fastener is a screw, and wherein each of the plurality of positioning holes is a threaded hole to be threaded through by the fastener.

12. The rotor for the motor as claimed in claim 1, wherein a plurality of nuts is integrally formed by injection on each of two ends of the elastic sleeve spaced from each other in the axial direction, wherein each of the two engaging units includes a plurality of positioning holes, and wherein a fastener is screwed through one of the plurality of positioning holes and a respective one of the plurality of nuts.

13. The rotor for the motor as claimed in claim 1, wherein the two engaging units are respectively adhered to two ends of the elastic sleeve spaced from each other in the axial direction.

14. The rotor for the motor as claimed in claim 13, wherein each of the two ends of the elastic sleeve is provided with a positioning protrusion, and wherein each of the two engaging units is fit around the positioning protrusion via the through-hole thereof.

15. The rotor for the motor as claimed in claim 1, wherein each of two ends of the permanent magnet spaced from each other in the axial direction includes a first engagement portion, wherein each of the two engaging units includes a second engagement portion at one of two ends of the engaging unit facing the permanent magnet, and wherein the first engagement portion corresponds to the second engagement portion.

16. The rotor for the motor as claimed in claim 15, wherein one of the first and second engagement portions is in a U shape and another of the first and second engagement portions is in the form of a U-shaped protrusion.

17. The rotor for the motor as claimed in claim 1, wherein the permanent magnet is an anisotropic magnet.

18. The rotor for the motor as claimed in claim 1, wherein each of the two engaging units includes a recess on an outer periphery thereof facing away from the elastic sleeve.

19. The rotor for the motor as claimed in claim 1, wherein each of the two engaging units includes a plurality of notches on an outer periphery thereof.

20. The rotor for the motor as claimed in claim 1, wherein each of the two engaging units is made of copper, aluminum or magnetically insulating steel.
